(19) United States
(12) Patent Application Publication
(10) Pub. No.: US 2024/0100907 A1
(43) Pub. Date: Mar. 28, 2024

(54) Air Conditioning Apparatus for Recreational Vehicles

(71) Applicant: Dometic Sweden AB, Solna (SE)

(72) Inventors: Enrico Paci, Forlì (IT); Andrea Cipressini, Forlì (IT)

(21) Appl. No.: 17/768,781

(22) PCT Filed: Oct. 15, 2020
(86) PCT No.: PCT/IB2020/059701

§ 371 Date: Apr. 13, 2022

(30) Foreign Application Priority Data
Oct. 17, 2019 (IT) 102019000019193

(51) Int. Cl. B60H 1/00; B60H 1/32

(52) U.S. Cl. CPC B60H 1/00364; B60H 1/00978; B60H 1/3217; B60H 2001/3238

(57) ABSTRACT

An air conditioning apparatus for recreational vehicles comprises a refrigeration circuit for circulating a refrigerant fluid, said refrigeration circuit including: a condenser, an expansion valve, an evaporator, in heat exchange with a room of the recreational vehicle to be air-conditioned, a compressor, and a leakage detection system, including: a refrigerant fluid sensor, configured to detect a control parameter representative of a physical condition of the refrigerant fluid at the outlet of the evaporator or at the inlet of the condenser; a control unit, connected to the refrigerant fluid sensor, and to the compressor.

### CLAIM TO PRIORITY

This 35 U.S.C. § 371 National Stage Patent application claims priority to and benefit of PCT Patent Application No. PCT/162020/059701, filed Oct. 15, 2020, which claims priority to and benefit of Italian Patent Application Serial Number IT 102019000019193 filed Oct. 17, 2019, all of which is incorporated by reference herein.

### TECHNICAL FIELD

Present embodiments relate to an air conditioning apparatus for recreational vehicles; moreover, but without limitation the present embodiments relate to a recreational vehicle and to a method for supplying conditioned air in a recreational vehicle.

### BACKGROUND ART

Air conditioning apparatuses for recreational vehicles usually comprise a refrigeration circuit for a refrigerant fluid, a condenser, an expansion device, an evaporator, a compressor and an electric motor for driving the compressor.

In particular, field of the present patent application is leakage detection of the refrigerant fluid in refrigeration system. In fact, the diffusion of natural refrigerant fluids, which are potentially explosive and/or toxic, made it essential to promptly detect a leakage of the refrigerant fluid, before it produces fires or explosions.

Leakage detections systems for refrigerant fluid are known, for example, from the following patent documents: EP3255360B1, WO2006025880A1, WO2013119489A2, U.S. Pat. No. 5,214,918A, GB2553972A, WO2013/119489A2, U.S. Pat. No. 7,558,700B2. The known systems have a limited reliability and rapidity in detecting leakages. Moreover, their architecture is complex.

### DISCLOSURE OF THE INVENTION

Present embodiments provide an air conditioning apparatus for a recreational vehicle and a method for detecting a leakage of refrigerant fluid in a refrigeration circuit for a recreational vehicle, which improves the above mentioned prior art.

This scope is achieved by the air conditioning apparatus and the method according to one or more of the appended claims.

The present disclosure relates to an air conditioning apparatus for recreational vehicles. The air conditioning apparatus (in the following: the apparatus) comprises a refrigerant fluid. The refrigerant fluid may be a natural refrigerant fluid, such as, for example, carbon dioxide (CO2, R-744), propane (R-290), isobutane (R-600a), propylene (R-1270), and ammonia (NH3, R-717).

The apparatus comprises a refrigeration circuit. The refrigeration circuit is configured for circulating the refrigerant fluid. The refrigeration circuit includes a first heat exchanger. The first heat exchanger is in heat exchange with an external environment (namely, provides heat exchange between the external environment and the refrigerant fluid). In a refrigeration mode, the first heat exchanger is configured for condensing the refrigerant fluid and, consequently, defines a condenser (in the following, the first heat exchanger is also indicated as condenser). The refrigeration circuit includes an expansion valve, configured for expanding the refrigerant fluid. The refrigeration circuit includes a second heat exchanger. The second heat exchanger is in heat exchange with a room of the recreational vehicle to be air-conditioned (namely, provides heat exchange between the room of the recreational vehicle and the refrigerant fluid). In the refrigeration mode, the second heat exchanger is configured for evaporating the refrigerant fluid and, consequently, defines an evaporator (in the following, the second heat exchanger is also indicated as evaporator). The refrigeration circuit includes a compressor, configured for compressing the refrigerant fluid.

In the refrigeration mode, the refrigerant fluid circulates from the compressor to the condenser, from the condenser to the expansion valve, from the expansion valve to the evaporator and from the evaporator back to the condenser. In particular, the evaporator has an inlet connected to the expansion valve and an outlet connected to the compressor. The condenser has an inlet connected to the compressor and an outlet connected to the expansion valve.

The apparatus further includes a leakage detection system. The leakage detection system includes a refrigerant fluid sensor, configured to detect a control parameter representative of a physical condition of the refrigerant fluid at the outlet of the evaporator or at the inlet of the condenser. The leakage detection system includes a control unit, connected to the refrigerant fluid sensor, and configured to receive (for example, in real time), the control parameter from the refrigerant fluid sensor. The control unit may include a PCB (printed circuit board).

The refrigerant fluid sensor may be, for example, a pressure sensor; in this case, the control parameter is representative of the pressure of the refrigerant fluid at the outlet of the evaporator or at the inlet of the condenser. Moreover, the refrigerant fluid sensor may be a temperature sensor; in this case, the control parameter is representative of the temperature of the refrigerant fluid at the outlet of the evaporator or at the inlet of the condenser.

According to an aspect of the present disclosure, the control unit is further connected to the compressor and is configured to receive from the compressor (for example, in real time), a compressor operation signal, representative of an operating status of the compressor. The control unit is configured to select reference values previously memorized in a database (which may be included in the apparatus or be remote), as a function of the compressor operation signal. The control unit is configured to compare the value (values) of the control parameter with the reference values, to generate a diagnostic parameter for assessing a leakage condition. The reference values provide a mapping of values to which the control parameter detected by the refrigerant fluid sensor is compared. For example, the reference values may include a minimum value and a maximum value for the control parameter.; in case the control parameter is not comprised between the minimum and the maximum value, the leakage condition is assessed. In another example, the reference values may include an optimal value and a tolerance value for the control parameter; in case the control parameter is not comprised between optimal value minus the tolerance value and the optimal value plus the tolerance value, the leakage condition is assessed.

The leakage detection system may further include a room temperature sensor. The room temperature sensor is configured to detect a room temperature signal, representative of a room temperature in the room to be air-conditioned. The room temperature sensor is connected to the control unit. The control unit is configured to receive in real time the room temperature signal from the room temperature sensor. The control unit is configured to select the reference values as a function of the room temperature signal (alternatively or additionally to as a function of the compressor operation signal).

In an embodiment, the leakage detection system further includes an outside environment temperature sensor. The outside environment temperature sensor is configured to detect an outside environment temperature signal, representative of an outside environment temperature in the outside environment (out of the recreational vehicle). The outside environment temperature sensor is connected to the control unit. The control unit may be configured to receive in real time the outside environment temperature signal from the outside environment temperature sensor. The control unit is configured to select the reference values as a function of the outside environment outside environment sensor (alternatively or additionally to as a function of the compressor operation signal and/or room temperature signal).

The control unit is connected (or connectable) to a memory. The memory may be included or not in the apparatus. The control unit is configured to store in the memory, for each of a plurality of successive time instants, the control parameter and/or the compressor operation signal received at the control unit. In particular, the plurality of successive time instants includes at least a preceding instant, which precedes the actual instant. The plurality of successive time instants may also include the actual instant. The control unit may be configured to compare the control parameter received in real time for the actual instant with the control parameter stored in the memory for the preceding instant, and to generate an alert signal as a function of a deviation of the control parameter received in real time for the actual time instant with respect to the control parameter stored in the memory for the preceding instant; in particular, the control unit may be configured to generate the alert signal if said deviation exceeds a reference threshold. The reference threshold is stored in the memory. Hence, the control unit may be configured to monitor a trend of the control parameter; this allows to promptly identify a leakage, as soon as it occurs.

The apparatus may include a monitor configured to display the diagnostic parameter (in particular, its value received in real time and/or its values at said plurality of time instants, providing a trend of the diagnostic parameter over time). Hence, the user may monitor the diagnostic parameter and switch off the apparatus and/or activate a safety procedure in case a leakage is assessed. Moreover, in at least one embodiment, the control unit may automatically command a stop of the apparatus as a function of the diagnostic parameter (for instance, by switching off the compressor).

The alert signal has the function to warn the user in case the control parameter is changing in an anomalous way (for instance, in case the pressure is decreasing too fast). Thus, the alert signal may constitute a clue that a leakage is present (although it may be indicative also of other defects). The alert signal may be displayed on the monitor, and/or may include a sound signal. It is here observed that the alert signal may define (coincide with) the diagnostic parameter, or may be a different signal.

In an embodiment, the alert signal may command a stop of the apparatus, which requires an action of the user to be reactivated (for instance, after having verified if a leakage is actually present by reading the diagnostic parameter).

The preceding instant may be a (single) initial time instant, wherein at each actual time instant the parameters which are received at the control unit in real time are compared with the ones stored in the memory for the (single) initial time instant (which remain the same). Alternatively, at each time instant of a plurality of successive time instants, the control unit may store in the memory an updated value of the parameters and compare the parameters received in real time with the ones stored in the memory for the instant which (immediately) precedes the actual time instant. In this case, a trend of the parameters over time is stored in the memory.

In at least an embodiment, the control unit is configured to select the reference threshold among a plurality of values stored in the database, as a function of the room temperature signal and/or of the outside temperature signal.

In at least an embodiment, the control unit is configured to select the reference threshold as a function of a difference between the compressor operation signal received in real time for the actual instant and the compressor operation signal stored in the memory for the preceding instant. It is here observed that the reference threshold may be selected as a function of the room temperature signal, and/or of the outside temperature signal, and/or of the compressor operation signal, and/or of the difference between the compressor operation signal for the actual instant and the compressor operation signal for the preceding instant.

According to an aspect of the present disclosure, the refrigerant fluid sensor is connected to the refrigeration circuit at the outlet of the evaporator. The leakage detection system may include an additional refrigerant fluid sensor, connected to the refrigeration circuit at the inlet of the condenser. The additional refrigerant fluid sensor is configured to detect an additional control parameter, representative of a physical condition of the refrigerant fluid at the inlet of the condenser.

The additional refrigerant fluid sensor may be, for example, a pressure sensor; in this case, the control parameter is representative of the pressure of the refrigerant fluid at the inlet of the condenser. Moreover, the additional refrigerant fluid sensor may be a temperature sensor; in this case, the control parameter is representative of the temperature of the refrigerant fluid at the inlet of the condenser.

The control unit may be further connected to the additional refrigerant fluid sensor. The control unit may be further configured to receive, in real time, the additional control parameter. Please observe that, in an embodiment, the additional refrigerant fluid sensor (at the inlet of the condenser) is provided and the refrigerant fluid sensor (at the outlet of the evaporator) is not provided.

In at least one embodiment, the control unit is configured to store in the memory, for each of the plurality of successive time instants, the additional control parameter. The control unit may be configured to generate the alert signal as a function of a (additional) deviation of the additional control parameter received in real time for the actual time instant with respect to the additional control parameter stored in the memory for the preceding instant. In particular, the control unit may be configured to generate the alert signal if said (additional) deviation exceeds a (additional) reference threshold. In at least an embodiment, the control unit is configured to select the (additional) reference threshold among a plurality of values stored in the database, as a function of the room temperature signal, and/or of the outside temperature signal, and/or of the compressor operation signal and/or of the difference between the compressor operation signal for the actual instant and the compressor operation signal for the preceding instant.

In at least one embodiment, the control unit is configured to select additional reference values previously memorized in the database, as a function of the compressor operation signal and/or the room temperature signal and/or of the outside temperature signal, and to compare the value of the control parameter with the reference values, to generate the diagnostic parameter for assessing the leakage condition.

In at least one embodiment, the control unit is configured to calculate a differential control parameter as a difference between the control parameter and the additional control parameter.

The control unit may be configured to select differential reference values previously memorized in the database, as a function of the compressor operation signal and/or of the room temperature signal and/or of the outside temperature signal, and to compare the differential control parameter with the reference values, to generate the diagnostic parameter. For example, the differential reference values may include a minimum value and a maximum value for the differential control parameter, or an optimal value and a tolerance value for the differential control parameter. The differential reference values may define the reference values, or being provided further to the reference values. It is here observed that the differential reference values depend on the status of the compressor (ON/OFF) and, consequently, may be selected on the basis of the compressor operation signal. In fact, when the compressor is switched off, the pressure of the refrigerant fluid is the same at the inlet of the condenser and at the outlet of the evaporator and, in absence of a leakage, has a value which varies with the temperature in the room and/or in the outside environment). When the compressor is switched on, the pressure of the refrigerant fluid is higher at the inlet of the condenser than at the outlet of the evaporator, and a difference between these pressures depends on the temperature in the room and/or in the outside environment.

The control unit may be configured store in the memory, for each of the plurality of successive time instants, the differential control parameter. The control unit may be configured to generate the alert signal as a function of a deviation of the differential control parameter calculated in real time for the actual time instant with respect to the differential control parameter stored in the memory for the preceding instant. In particular, the control unit may be configured to generate the alert signal if said deviation between the differential control parameter calculated in real time for the actual time instant and the differential control parameter stored in the memory for the preceding instant exceeds a differential reference threshold. In at least an embodiment, the control unit is configured to select the differential reference threshold among a plurality of values stored in the database, as a function of the room temperature signal and/or of the compressor operation signal and/or of the difference between the compressor operation signal for the actual instant and the compressor operation signal for the preceding instant and/or of the outside temperature signal.

According to an aspect of the present disclosure, the control unit is configured to calculate a leakage parameter, as a function of one or more of the following: control parameter, additional control parameter, differential control parameter, room temperature measured in the room to be air conditioned, outside environment temperature. The control unit is configured to compare the leakage parameter with minimum and/or a maximum threshold previously memorized, to generate the diagnostic parameter. The minimum and/or a maximum threshold for the leakage parameter are fixed, namely they are not variable with the room temperature or the power absorbed by the compressor.

For example, the leakage parameter may be calculated as a difference between the pressure at the inlet of the condenser and the pressure at the outlet of the evaporator, the difference being divided by the pressure at the inlet of the condenser (or by the pressure at the outlet of the evaporator). In at least an embodiment, the control unit is configured to select the minimum and/or the maximum threshold among a plurality of values stored in the database, as a function of the room temperature signal and/or of the compressor operation signal and/or of the difference between the compressor operation signal for the actual instant and the compressor operation signal for the preceding instant and/or of the outside temperature signal.

According to an embodiment the present disclosure, the leakage detection system includes a power sensor (or current sensor) connected to the compressor and configured to measure a power (or current) absorbed by the compressor; in this case, the compressor operation signal may be representative of a power (or current) absorbed by the compressor. According to another embodiment, the compressor operation signal may be a binary parameter representative of a status of the compressor (ON or OFF).

In at least one embodiment, the apparatus comprises a four-way valve, connected to the refrigeration circuit and operable in a first position, to operate the apparatus in the refrigeration mode, and in a second position, to operate the apparatus in a heating mode.

In the heating mode, the first heat exchanger is configured for evaporating the refrigerant fluid and, consequently, works as an evaporator. In the heating mode, the second heat exchanger is configured for condensing the refrigerant fluid and, consequently, works as a condenser.

In the heating mode, the refrigerant fluid circulates from the compressor to the condenser (which is, in this mode, the second heat exchanger), from the condenser to the expansion valve, from the expansion valve to the evaporator (which is, in this mode, the first heat exchanger) and from the evaporator back to the condenser.

The control unit may be configured to select the reference values (and/or the additional reference values, and/or the differential reference values, and or the minimum and/or maximum threshold for the leakage parameter) among a plurality of values memorized in the database, also as a function of the four-way valve being in the first position or in the second position.

The present disclosure also provides a method for detecting a leakage of refrigerant fluid in a refrigeration circuit for (of) a recreational vehicle.

The method comprises a step of detecting a control parameter, representative of a physical condition (pressure or temperature) of the refrigerant fluid at the outlet of the evaporator or at the inlet of the condenser.

The method comprises a step of receiving in real time, at a control unit, the control parameter and a compressor operation signal, representative of an operating status of the compressor.

According to an aspect of the present disclosure, the method comprises a step of selecting reference values previously memorized in a database, as a function of the compressor operation signal; also, the method comprises a step of comparing the value of the control parameter with the reference values, and generating a diagnostic parameter for assessing a leakage condition.

The method may further comprise a step of detecting a room temperature signal, representative of a room temperature in the room to be air-conditioned, through a room temperature sensor. Then, the method comprises a step of receiving (for example, in real time) the room temperature signal at the control unit. In this case, the reference values may be selected also as a function of the room temperature signal.

The method may further comprise a step of detecting an outside environment temperature signal, representative of an outside environment temperature in the outside environment, through an outside environment temperature sensor. Then, the method comprises a step of receiving (for example, in real time) the outside environment temperature signal at the control unit. In this case, the reference values may be selected also as a function of the outside temperature environment signal.

In at least one embodiment, the method comprises a step of storing in a memory, for each of a plurality of successive time instants, the control parameter and the compressor operation signal received at the control unit. In particular, the plurality of successive time instants includes at least a preceding instant, which precedes an actual instant. The method may further comprise a step of comparing the control parameter received in real time for the actual instant with the control parameter stored in the memory for the preceding instant and generating an alert signal as a function of a deviation of the control parameter received in real time for the actual time instant with respect to the control parameter stored in the memory for the preceding instant. In particular, the alert signal is generated if the deviation exceeds a reference threshold. In at least one embodiment, the method may further include a step of selecting the reference threshold as a function of a difference between the compressor operation signal received in real time for the actual instant and the compressor operation signal stored in the memory for the preceding instant and/or as a function of the room temperature signal and/or of the outside environment temperature signal.

In at least one embodiment, the control parameter is representative of a physical condition of the refrigerant fluid at the outlet of the evaporator and the method comprises a step of detecting an additional control parameter, representative of a physical condition of the refrigerant fluid at the inlet of the condenser.

The method may further comprise a step of calculating a differential control parameter as a difference between the control parameter and the additional control parameter.

In at least one embodiment, the method comprises a step of selecting differential reference values previously memorized in the database, as a function of the compressor operation signal and/or of the room temperature signal, and/or of the outside environment temperature signal, and a step of comparing the differential control parameter with the reference values, to generate the diagnostic parameter.

According to one aspect of the present disclosure, the method comprises a step of calculating a leakage parameter, as a function of one or more of the following: control parameter, additional control parameter, differential control parameter, room temperature measured in the room to be air conditioned, the outside environment temperature measured in the outside environment. Thus, the method may comprise a step of comparing the leakage parameter with minimum and/or a maximum threshold previously memorized, to generate the diagnostic parameter. The method may also include a step of selecting the minimum and/or the maximum threshold among a plurality of values stored in the database, as a function of the room temperature signal and/or of the compressor operation signal and/or of the difference between the compressor operation signal for the actual instant and the compressor operation signal for the preceding instant and/or of the outside environment temperature signal.

The method may also comprise a step of calibration, including deriving the reference values and memorizing them in the database. The reference values are derived by operating the apparatus in a plurality of situations having a specific room temperature and/or power absorbed by the compressor and/or outside environment temperature, and detecting the values of the control parameter and/or of the additional control parameter in these situations. The detected values (eventually corrected by a certain tolerance) provide the reference values.

### BRIEF DESCRIPTION OF DRAWINGS

This and other features of the invention will become more apparent from the following detailed description of a non-limiting example embodiment of it, with reference to the accompanying drawings, in which:

FIG. 1 illustrates an air conditioning apparatus according to the present disclosure;

FIG. 2 illustrates a possible embodiment of the air conditioning apparatus of claim 1, wherein the apparatus is operable in a refrigeration mode and in a heating mode;

FIG. 3 illustrates possible variation of the control parameter as a function of the room temperature in the room to be air-conditioned and of the power absorbed by the compressor (in particular, each curve illustrated in FIG. 3 represents possible values of the control parameter for a certain power absorbed by the compressor, as a function of the room temperature).

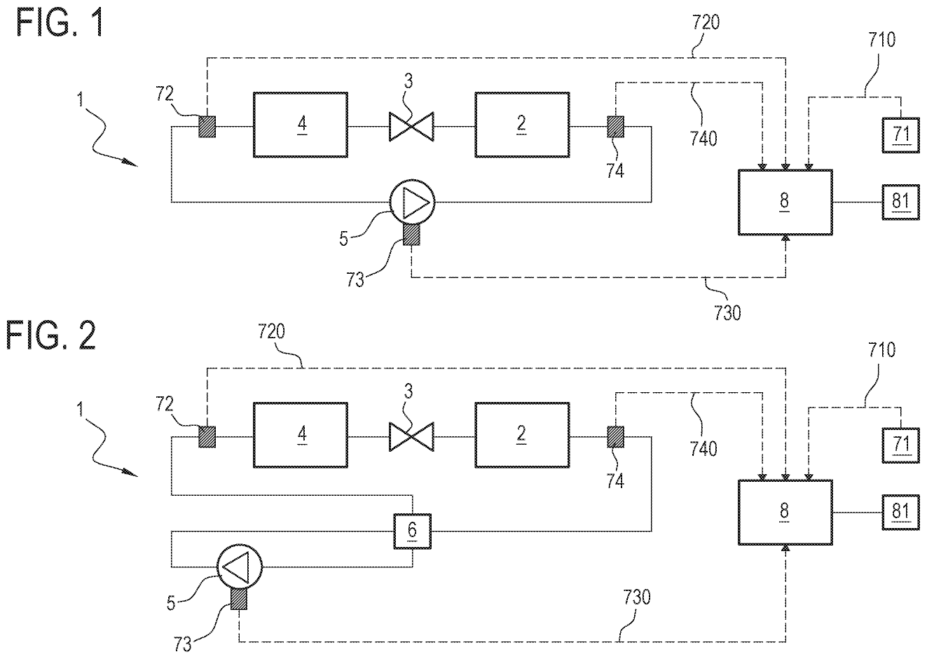

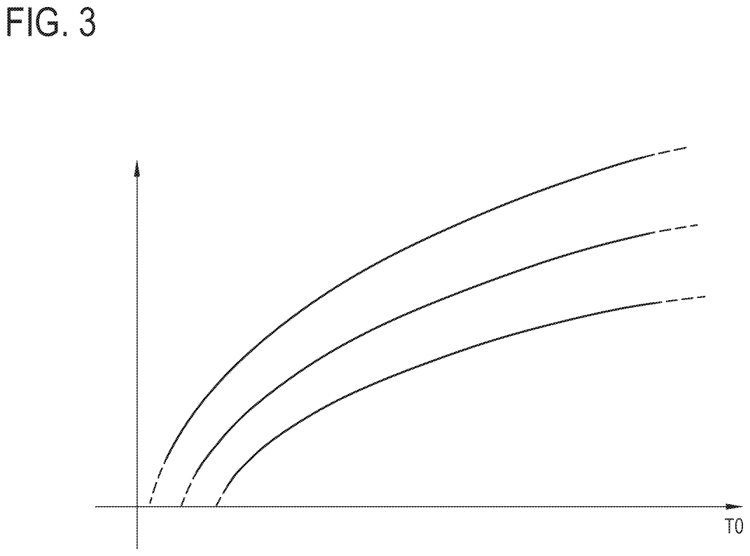

### DETAILED DESCRIPTION OF EMBODIMENTS

With reference to the accompanying drawings, the numeral 1 denotes an air conditioning apparatus for recreational vehicles (in the following, the apparatus).

The air conditioning apparatus comprises a refrigeration circuit for circulating the refrigerant fluid. The refrigeration circuit includes a condenser 2, an expansion valve 3, an evaporator 4 and a compressor 5. It is here observed that the terms “condenser” and “evaporator” are referred to an operation of the refrigeration circuit in a refrigeration mode.

The air conditioning apparatus comprises a leakage detection system. The leakage detection system includes one or more of the following:
a refrigerant fluid sensor 72, connected to the refrigeration circuit at the outlet of the evaporator 4 (namely, in a branch of the circuit comprised between the evaporator 4 and the compressor 5), and configured to detect a temperature or a pressure of the refrigerant fluid;
an additional refrigerant fluid sensor 74, connected to the refrigeration circuit at the inlet of the condenser 2 (namely, in a branch of the circuit comprised between the condenser 2 and the compressor 5), and configured to detect a temperature or a pressure of the refrigerant fluid;
a power sensor (or current sensor) 73, connected to the compressor 5 and configured to measure an electrical power (or current) absorbed by the compressor 5.

The leakage detection system comprises a control unit 8, connected to the refrigerant fluid sensor 72, and/or to the additional refrigerant fluid sensor 74, and/or to the power sensor 73.

In particular, the refrigerant fluid sensor 72 (if provided) is configured to send to the control unit 8 a control parameter 720, representative of the temperature or of the pressure of the refrigerant fluid in the branch of the circuit comprised between the evaporator 4 and the compressor 5.

The additional refrigerant fluid sensor 74 (if provided) is configured to send to the control unit 8 an additional control parameter 740, representative of the temperature or of the pressure of the refrigerant fluid in the branch of the circuit comprised between the condenser 2 and the compressor 5.

Both the refrigerant fluid sensor 72 and the additional refrigerant fluid sensor 74 are pressure sensors, configured to detect a pressure value of the refrigerant fluid in the branch of the circuit comprised between the evaporator 4 and the compressor 5 or in the branch of the circuit comprised between the condenser 2 and the compressor 5, respectively.

The power sensor 73 (if provided) is configured to send to the control unit 8 a compressor operator signal 730, representative of an operating status of the compressor (in particular, in an embodiment, of the actual power absorbed by the compressor 5).

The leakage detection system further comprises a room temperature sensor 71, configured to detect a room temperature TO in the room of the recreational vehicle to be air conditioned. The room temperature sensor 71 is connected to the control unit 8 and is configured to send to the control unit 8 a room temperature signal 710, representative of the room temperature TO.

In an embodiment, the control unit 8 is connected to a database (which may be included or not in the apparatus), the database including a plurality of reference values. The control unit 8 is configured to select one or more reference values among said plurality, as a function of one or more of the following:
the compressor operator signal 730;
the room temperature signal 710.

In an embodiment, the control unit 8 is configured to compare the value of the control parameter 720 and/or of the additional control parameter 740 with the reference values, to generate a diagnostic parameter for assessing a leakage condition.

In an embodiment, the control unit 8 is configured to calculate a differential control parameter as a difference between the control parameter 720 and the additional control parameter 740.

In an embodiment, the control unit 8 configured to calculate a leakage parameter, as a function one or more of the following: control parameter 720, additional control parameter 740, room temperature TO, differential parameter.

In an embodiment, the control unit 8 is connected to a memory 81 (which may be included or not in the apparatus 1) and is configured to store in the memory 8, for at least for an initial time instant (or, for each of a plurality of successive time instant equally distanced from each other) or more of the following:
control parameter 720;
additional control parameter 740;
room temperature TO;
differential control parameter;
leakage parameter.

In an embodiment, the control unit 8 is configured to compare the control parameter 720 received in real time with the control parameter stored in the memory 81 for the initial time instant or for a preceding instant of the plurality of time instants, and to generate an alert signal in case a deviation between the control parameter 720 received in real time and the control parameter stored in the memory 81 exceeds a certain threshold (which may be selected by the memory as a function of the room temperature TO, and/or as a function of a difference between the room temperature TO at the actual time instant and the room temperature at the initial time instant, or at the preceding instant, and/or as a function of the compressor operator signal 730, and/or as a function of a difference between the compressor operator signal 730 at the actual time instant and the compressor operator signal 730 at the initial time instant, or at the preceding instant).

In an embodiment, the control unit 8 is configured to compare the additional control parameter 740 received in real time with the control parameter stored in the memory 81 for the initial time instant of for a preceding instant of the plurality of time instants, and to generate an alert signal in case a deviation between the additional control parameter 740 received in real time and the additional control parameter stored in the memory 81 exceeds a certain threshold (which may be selected by the memory as a function of the room temperature TO, or as a function of a difference between the room temperature TO at the actual time instant and the room temperature at the initial time instant, or at the preceding instant and/or as a function of the compressor operator signal 730, and/or as a function of a difference between the compressor operator signal 730 at the actual time instant and the compressor operator signal 730 at the initial time instant, or at the preceding instant).

In an embodiment, the control unit 8 is configured to compare the differential control parameter calculated in real time with the differential control parameter stored in the memory 81 for the initial time instant of for a preceding instant of the plurality of time instants, and to generate an alert signal in case a deviation between the differential control parameter calculated in real time and the differential control parameter stored in the memory 81 exceeds a certain threshold (which may be selected by the memory as a function of the room temperature TO, or as a function of a difference between the room temperature TO at the actual time instant and the room temperature at the initial time instant, or at the preceding instant and/or as a function of the compressor operator signal 730, and/or as a function of a difference between the compressor operator signal 730 at the actual time instant and the compressor operator signal 730 at the initial time instant, or at the preceding instant).

In an embodiment, the control unit 8 is configured to compare the leakage parameter calculated in real time with reference values (e.g. maximum and minimum threshold) and generate the diagnostic parameter and/or the alert signal as a function of said comparison (e.g. in case the leakage parameter exceeds the maximum threshold or decreases below the minimum threshold).

In an embodiment, the apparatus 1 comprises a four-way valve 6. The four-way valve 6 is connected to the refrigeration circuit between the condenser 2 and the evaporator 4 (specifically, between the refrigerant fluid sensor 72 and the additional refrigerant fluid sensor 74). The four-way valve 6 has a first port connected to the branch of the refrigerant circuit connected to the evaporator 4, for receiving (in the refrigeration mode) the refrigerant fluid from the evaporator 4. The four-way valve 6 has a second port connected to the branch of the refrigerant circuit connected to the condenser 2, for sending (in the refrigeration mode) the refrigerant fluid to the condenser 2. It is here observed that, in the heating mode, the first port releases the refrigerant fluid and the second port receives the refrigerant fluid. The four-way valve has a third port, connected to the inlet of the compressor 5, for sending the refrigerant fluid to the compressor (both in the refrigeration mode and in the heating mode). The four-way valve 6 has a fourth port, connected to the outlet of the compressor 5, for receiving the refrigerant fluid from the compressor (both in the refrigeration mode and in the heating mode). The four-way valve 6 is operable in a first position, to receive the refrigerant fluid at the first port and releasing the (compressed) refrigerant fluid at the second port, and in a second position, to receive the refrigerant fluid at the second port and releasing the (compressed) refrigerant fluid at the first port. In the first position of the four-way valve, the apparatus is operated in the refrigeration mode and, in the second position of the four-way valve, the apparatus is operated in the heating mode.

The expansion valve 3 may be a mechanical valve or an electronic valve. In case it is an electronic valve, the control unit 8 is also connected to the expansion valve 3, to control the expansion valve 3. In an embodiment, the control unit 8 controls the expansion valve 3 as a function of the control parameter 720 detected at the outlet of the evaporator 4 (in particular, representing a pressure of the refrigerant fluid at the outlet of the evaporator 4) and as a function of the room temperature TO.

1. An air conditioning apparatus for recreational vehicles, comprising:
a refrigerant fluid;
a refrigeration circuit for circulating the refrigerant fluid, said refrigeration circuit including:
a condenser, in heat exchange with an external environment and configured to condense the refrigerant fluid;
an expansion valve, configured to expanding the refrigerant fluid;
an evaporator, in heat exchange with a room of the recreational vehicle to be air-conditioned and configured to evaporating the refrigerant fluid;
a compressor, configured to compress the refrigerant fluid,
wherein the evaporator has an inlet connected to the expansion valve and an outlet connected to the compressor and the condenser has an inlet connected to the compressor and an outlet connected to the expansion valve;
a leakage detection system, including:
a refrigerant fluid sensor, configured to detect a control parameter representative of a physical condition of the refrigerant fluid at the outlet of the evaporator or at the inlet of the condenser;
a control unit, connected to the refrigerant fluid sensor,
wherein the control unit is further connected to the compressor and is configured to:
receive, in real time, the control parameter from the refrigerant fluid sensor and a compressor operation signal, representative of an operating status of the compressor, from the compressor,
select reference values previously memorized in a database, as a function of the compressor operation signal,
compare the value of the control parameter with the reference values, to generate a diagnostic parameter for assessing a leakage condition.

2. The air conditioning apparatus of claim 1, wherein the leakage detection system further comprises a room temperature sensor, configured to detect a room temperature signal, representative of a room temperature in the room to be air-conditioned, wherein the control unit is configured to receive in real time the room temperature signal from the room temperature sensor and to select the reference values also as a function of the room temperature signal.

3. The air conditioning apparatus of claim 2, further comprising a memory, wherein the control unit is connected to the memory and is configured to store in the memory, for each of a plurality of successive time instants, the control parameter and the compressor operation signal received at the control unit.

4. The air conditioning apparatus of claim 3, wherein the plurality of successive time instants includes at least a preceding instant, which precedes an actual instant, and wherein the control unit is configured to compare the control parameter received in real time for the actual instant with the control parameter stored in the memory for the preceding instant and to generate an alert signal as a function of a deviation of the control parameter received in real time for the actual time instant with respect to the control parameter stored in the memory for the preceding instant.

5. The air conditioning apparatus of claim 4, wherein the control unit is configured to generate the alert signal if said deviation exceeds a reference threshold, wherein the control unit is configured to select the reference threshold as a function of a difference between the compressor operation signal received in real time for the actual instant and the compressor operation signal stored in the memory for the preceding instant.

6. The air conditioning apparatus of claim 1, wherein the refrigerant fluid sensor is connected to the refrigeration circuit at the outlet of the evaporator, and wherein the leakage detection system includes an additional refrigerant fluid sensor, connected to the refrigeration circuit at the inlet of the condenser, and configured to detect an additional control parameter representative of a physical condition of the refrigerant fluid at the inlet of the condenser, wherein the control unit is connected to the additional refrigerant fluid sensor to receive, in real time, the additional control parameter and is configured to calculate a differential control parameter as a difference between the control parameter and the additional control parameter.

7. The air conditioning apparatus of claim 6, wherein the control unit is configured to select differential reference values previously memorized in the database, as a function of the compressor operation signal, and to compare the differential control parameter with the differential reference values, to generate the diagnostic parameter.

8. The air conditioning apparatus of claim 7, wherein the control unit is configured to calculate a leakage parameter, as a function of the differential control parameter and one or more of the following: control parameter, additional control parameter, room temperature measured in the room to be air conditioned, and
compare the leakage parameter with minimum and/or a maximum threshold previously memorized, to generate the diagnostic parameter.

9. The air conditioning apparatus of claim 1, wherein the refrigerant fluid sensor is a pressure sensor.

10. The air conditioning apparatus of claim 9, wherein the control parameter is representative of a pressure of the refrigerant fluid at the outlet of the evaporator, and wherein the leakage detection system includes an additional refrigerant fluid sensor, which is a pressure sensor, configured to detect an additional control parameter representative of a pressure of the refrigerant fluid at the inlet of the condenser.

11. The air conditioning apparatus of claim 1, wherein the leakage detection system includes a power sensor connected to the compressor and configured to measure a power absorbed by the compressor, wherein the compressor operation signal is representative of the power absorbed by the compressor.

12. The air conditioning apparatus of claim 1, comprising a four-way valve, connected to the refrigeration circuit and operable in a first position, to operate the apparatus in a refrigeration mode, and in a second position, to operate the apparatus in a heating mode, wherein the control unit is configured to select the reference values also as a function of the four-way valve being in the first position or in the second position.

13. A method for detecting a leakage of refrigerant fluid in a refrigeration circuit for a recreational vehicle, wherein the refrigeration circuit includes a condenser, in heat exchange with an external environment, an expansion valve, an evaporator, in heat exchange with a room of the recreational vehicle to be air-conditioned, a compressor, wherein the method comprises the following steps:
detecting a control parameter, representative of a physical condition of the refrigerant fluid at an outlet of the evaporator or at an inlet of the condenser;
receiving in real time, at a control unit the control parameter and a compressor operation signal, representative of an operating status of the compressor,
selecting reference values previously memorized in a database, as a function of the compressor operation signal,
comparing the value of the control parameter with the reference values, and generating a diagnostic parameter for assessing a leakage condition.

14. The method of claim 13, wherein the control parameter is representative of a physical condition of the refrigerant fluid at the outlet of the evaporator, and wherein the method further comprises a step of detecting an additional control parameter, representative of a physical condition of the refrigerant fluid at the inlet of the condenser and a step of calculating a differential control parameter as a difference between the control parameter and the additional control parameter.

15. The method of claim 13, wherein the control parameter is representative of a pressure of the refrigerant fluid.
